(19) United States
(12) Patent Application Publication
(10) Pub. No.: US 2025/0305622 A1
(43) Pub. Date: Oct. 2, 2025

(54) RECIPROCATING SWIVEL BASE

(71) Applicant: Xuan Huada (Shenzhen) Technology Co., Ltd., Shenzhen (CN)

(72) Inventor: Jing Wang, Zhumadian (CN)

(21) Appl. No.: 18/620,421

(22) Filed: Mar. 28, 2024

(51) Int. Cl. F16M 11/20; F16H 19/00; F16H 55/26

(52) U.S. Cl. CPC F16M 11/2014; F16H 19/001; F16H 55/26

(57) ABSTRACT

The present invention discloses a reciprocating swivel base for the field of daily supplies, including an enclosure, a plastic column, steel balls, a connecting dowel pin, a reciprocating swivel assembly and a bearing. The enclosure is a circular shell that clamps the rotating plastic column in the opening; the steel balls are mounted on the surface where the plastic column joins the enclosure; the driving gear is fixed to the bottom of the plastic column by the connecting dowel pin and engaged with teeth on the slide; the slide is connected by the connecting rod to the crank that connects the gear set, and a motor is connected to the gear set. The mechanism provided by this invention has the advantages of stable operation, low noise, long life and strong immunity to external interference, and it is well worth popularizing.

### FIELD OF THE INVENTION

The present invention relates to a reciprocating swivel base used in the field of daily supplies.

### BACKGROUND

Swivel bases are an indispensable part of our lives and in our work. A good swivel base can make a stationary object come to life and enable 360° repetitive presentation of stationary objects.

The bases currently available on the market may be either rotary or non-rotary, which are both realized by the different base modules. Rotary bases generally cannot rotate quietly and stably. As conventional mechanisms are realized by changing running direction of the motor, they can only rotate by switching positive and negative electrodes of the motor, and the rotary mechanism cannot run smoothly. In addition, the motor life is significantly reduced due to frequently direction changes, and the operating mechanism fails when exposed to external damages and interference.

### SUMMARY OF THE INVENTION

Given the aforementioned technical deficiencies, the present invention is intended only to solve the problems that the currently available reciprocating swivel bases fail to automatically rotate in a stable and reciprocating manner in the long run and that the mechanism is not stable enough.

The present invention provides the technical proposal below to solve the aforementioned technical issues:

The present invention provides a reciprocating swivel base, including an enclosure, a plastic column, steel balls, a connecting dowel pin, a reciprocating swivel assembly and a bearing; wherein the enclosure is a circular shell that clamps the rotating plastic column in the opening; the steel balls are mounted on the surface where the plastic column joins the enclosure; the driving gear is fixed to the bottom of the plastic column by the connecting dowel pin and engaged with teeth on the slide; the slide is connected by the connecting rod to the crank that connects the gear set; a motor is connected to the gear set, and the bearing is installed in the plastic column.

Preferably, the plastic column runs efficiently in the enclosure at a low abrasion rate by the aid of the steel balls.

Preferably, the enclosure is made of PP or nylon.

Preferably, the steel balls are made of abrasion-resistant metallic material.

Preferably, the gear set runs stably in a reciprocating manner, which is not realized by changing running direction of the motor.

The advantages of the present invention include:

The reciprocating swivel base provided by the present invention utilizes an eccentric block powered by the motor to drive the connecting rod that drives the central gear via the rack so the plastic column driven by the central gear runs. It is easy to use. In addition, steel balls are used instead of bearings so the plastic column fits better with the enclosure, thus reducing the noise and the cost and enhancing the durability. Besides, the motor runs in a single direction so it is more stable and has a longer life.

### BRIEF DESCRIPTION OF THE DRAWINGS

The accompanying drawings for the embodiment or available technology are described as follows in order for a detailed description of various exemplary embodiments of the present invention or technical proposals of available technology.

It should be appreciated that the following drawings relates only to partial embodiments of the present invention. One of ordinary skill in the art may obtain more drawings accordingly without any creative work.

FIG. 1 is a structural diagram of a reciprocating swivel base provided by the present invention.

FIG. 2 is a schematic diagram of the reciprocating swivel assembly.

FIG. 3 is a back view of the base.

Reference numerals on the drawings: 1. enclosure; 2. plastic column; 3. steel ball; 4. connecting dowel pin; 5. reciprocating swivel assembly; 501. motor; 502. gear set; 503. crank; 504. connecting rod; 505. slide; 506. driving gear; 6. bearing.

### DETAILED DESCRIPTION OF THE PREFERRED EMBODIMENT

The technical proposal of the embodiment is described clearly and thoroughly as follows by referring to the accompanying drawings. It should be appreciated that the embodiment disclosed herein is merely illustrative and do not limit the scope of the invention. All other embodiments obtained based on the one included herein by one of ordinary skill in the art without creative work are under the protection of the present invention.

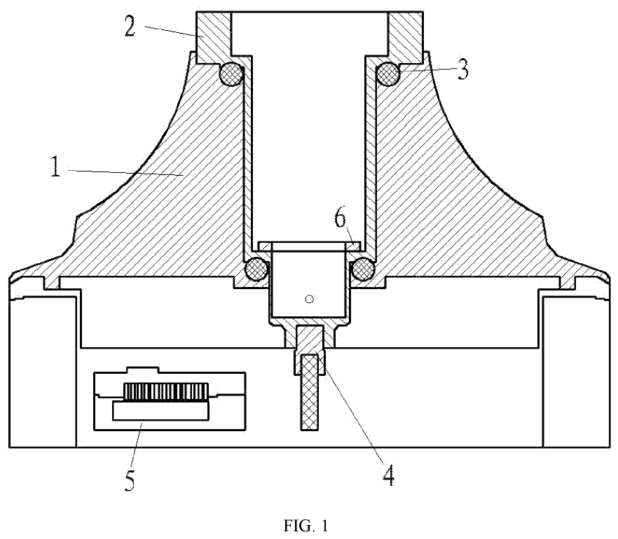

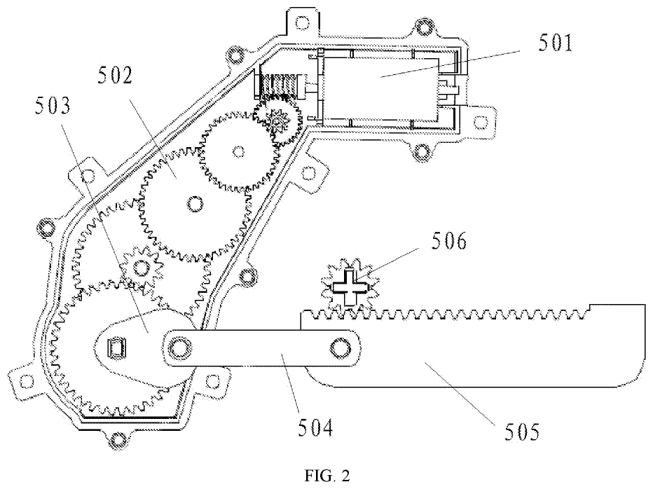

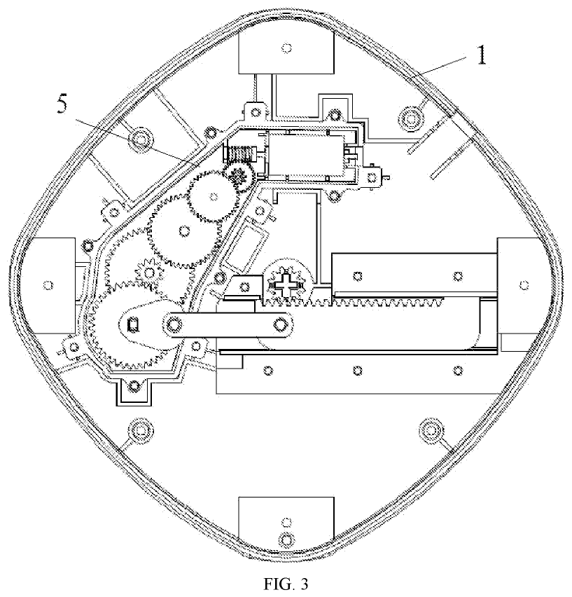

FIGS. 1-3 show an embodiment of a reciprocating swivel base that includes an enclosure 1, a plastic column 2, steel balls 3, a connecting dowel pin 4, a reciprocating swivel assembly 5 and a bearing 6; wherein the enclosure 1 is a circular shell that clamps the rotating plastic column 2 in the opening; the steel balls 3 are mounted on the surface where the plastic column 2 joins the enclosure 1; the driving gear 506 is fixed to the bottom of the plastic column 2 by the connecting dowel pin 4 and engaged with teeth on the slide 505; the slide 505 is connected by the connecting rod 504 to the crank 503 that connects the gear set 502; a motor 501 is connected to the gear set 502, and the bearing 6 is installed in the plastic column 2.

Further, the plastic column 2 runs efficiently in the enclosure 1 at a low abrasion rate by the aid of the steel balls 3.

Further, the enclosure 1 is made of PP or nylon.

Further, the steel balls 3 are made of abrasion-resistant metallic material.

Further, the gear set runs stably in a reciprocating manner, which is not realized by changing running direction of the motor.

Principle of rotational motion of the base:
(1): The motor, when electrified, supplies the driving power;
(2): The gear set drives the crank at a certain ratio;
(3): The crank connected to the slide by the connecting rod drives the slide to move in a reciprocating manner;
(4): When the slide engages with the driving gear, the enclosure is driven to make reciprocating and rotational motion;
(5): In the case of stalling by an external force during reciprocating and rotational motion of a load, the load slips on the base via the bearing and rotates with the bearing, thus avoiding overloading of the motor.

The advantages of the present invention include:

The reciprocating swivel base provided by the present invention utilizes an eccentric block powered by the motor to drive the connecting rod that drives the central gear via the rack so the plastic column driven by the central gear runs. It is easy to use. In addition, steel balls are used instead of bearings so the plastic column fits better with the enclosure, thus reducing the noise and the cost and enhancing the durability. Besides, the motor runs in a single direction so it is more stable and has a longer life.

It should be realized by those skilled in the art that the modifications and variants of the present invention do not depart from the spirit and scope of the present invention. Accordingly, the present invention is intended to include the modifications and variants within the scope of the claims of the present invention and its equivalent technologies.

1. A reciprocating swivel base, characterized in that: including an enclosure (1), a plastic column (2), steel balls (3), a connecting dowel pin (4), a reciprocating swivel assembly (5) and a bearing (6);
wherein the enclosure (1) is a circular shell that clamps the rotating plastic column (2) in the opening; the steel balls (3) are mounted on the surface where the plastic column (2) joins the enclosure (1); the driving gear (506) is fixed to the bottom of the plastic column (2) by the connecting dowel pin (4) and engaged with teeth on the slide (505); the slide (505) is connected by the connecting rod (504) to the crank (503) that connects the gear set (502); a motor (501) is connected to the gear set (502), and the bearing (6) is installed in the plastic column (2).

2. The reciprocating swivel base of claim 1, characterized in that: the plastic column (2) rotates in the enclosure (1) by the aid of the steel balls (3).

3. The reciprocating swivel base of claim 1, characterized in that: the enclosure (1) is made of PP or nylon.

4. The reciprocating swivel base of claim 1, characterized in that: the steel balls (3) are made of abrasion-resistant metallic material.
